(19) United States
(12) Patent Application Publication
(10) Pub. No.: US 2012/0091668 A1
(43) Pub. Date: Apr. 19, 2012

(54) HEAT-RESISTANT SEAL MEMBER

(75) Inventors: Katsumi Motegi, Shuzuoka (JP); Hajime Tsuda, Shizuoka (JP); Yusuke Takechi, Shizuoka (JP)

(73) Assignee: Tomoegawa Co., Ltd., Chuo-ku (JP)

(21) Appl. No.: 13/378,946

(22) PCT Filed: Jun. 4, 2010
(86) PCT No.: PCT/JP10/03766

§ 371 Date: Dec. 16, 2011

(30) Foreign Application Priority Data
Jun. 19, 2009 (JP) 2009-146659

(51) Int. Cl. F16J 15/02; B29C 41/00; B32B 19/02

(52) U.S. Cl. 277/590; 428/221; 264/299

(57) ABSTRACT

To provide a means for achieving sufficient sealing performance even in the case of using a highly heat resistant clay film in a high temperature environment exceeding 600° C., minimizing deterioration thereof caused by structural change even in a high temperature environment exceeding 600° C. in the presence of water, and preventing decline in the function of the product caused by the elution of sodium. A member containing a clay film which contains aligned clay particles in the structure thereof and contains, among the clay particles and/or among clay particle layers, a substance decomposing at temperatures, exceeding 100° C. but not exceeding the temperature allowing the release, as water, of structural hydroxyl groups in the clay particles, wherein the member is to be employed in an environment of equal or higher temperatures than the decomposition temperature of the aforesaid substance.

### BACKGROUND OF THE INVENTION

The present invention relates to a novel material having heat resistance even in a high temperature region of higher than 600° C. and an excellent sealing property, which can be appropriately used as a gasket, for example.

As a seal member to be used in a high temperature region, a gasket composed mostly of rubber, fibers, or clay; a metal gasket, or a glass seal member is used. The gasket mostly made of rubber, fibers, or clay cannot be used in a relatively high temperature region, e.g., a temperature region of 500° C. or more, due to heat resistance of rubber. For such a high temperature region, a metal gasket or a glass seal member is used. However, the metal glass is problematic in that it is heavy and requires high fastening pressure. Meanwhile, the glass seal can melt in a high temperature region and is fixed by decreasing a temperature to exhibit its sealing property. However, it is problematic in that sodium as a glass component is eluted after use for a long period of time to cause corrosion of an electrode, a metal, or other members, or deterioration of the performance. Further, there is an additional problem that, when a seal part is subjected to disassembly for maintenance etc. due to complete fixing, it is difficult to disassemble.

### SUMMARY OF THE INVENTION

As a new material having heat resistance, a novel thin clay film with mechanical strength enabling the use as a self-supporting film has recently been suggested (Japanese Patent No. 3855003). According to the method described in this patent document, clay is dispersed in a liquid like water or a dispersion medium comprising water as a main component, thus prepared clay dispersion is flown in a tray, for example, and maintained in horizontal state to precipitate clay particles while the liquid as a dispersion medium is simultaneously separated by a solid-liquid separation means followed by molding it into a film shape. The thin clay film obtained by this method has a structure in which layered clay particles are highly aligned. The thin clay film has mechanical strength enabling the use as a self-supporting film and characteristics like excellent flexibility at high temperatures exceeding 250° C. and excellent barrier property against gas and liquid.

As described in the patent document, the thin clay film relating to Japanese Patent No. 3855003 can be used at high temperature condition exceeding 250° C. However, at the temperatures exceeding 600° C., a structural change due to release of structural hydroxyl groups occurs, and therefore the film is not so appropriate to be used in an environment with extremely high temperature (see, paragraph [0001], etc. of Japanese Patent No. 3855003). Further, assuming that the thin clay film is used as a gasket, it is believed that the gas barrier property is extremely high. However, if the gasket is not thoroughly fastened to the degree that it is fully deformed to conform to the shape of a flange plane, leakage of gas or liquid will easily occur. In this regard, even when the clay thin film according to Japanese Patent No. 3855003 is deformed for conformation, not only the thin clay film of Japanese Patent No. 3855003 cannot exhibit a sufficient sealing property due to insufficient elasticity in thickness direction but also the thin clay film is hardened by thermal deterioration of the film itself at the temperatures exceeding 600° C. as aforementioned, and as a result, a structural disruption such as cracks, fissures, etc. may be yielded. Further, although the clay particles of the thin clay film are in an electrically neutral state because the sodium ions are present in negatively charged interlayer, the interlayer sodium ions are eluted from the particles in an environment having moisture. Thus, it is believed that, when the thin clay film is used in an environment with moisture and high temperatures exceeding 600° C., for example as a gasket for a solid oxide type fuel cell, a structural change and sodium elution occur, thereby preventing the use of the film.

Furthermore, Japanese Patent Application Laid-Open (JP-A) No. 2006-188418 discloses a method of forming (expanding) voids in a film by a heat treatment and evaporation of moisture included in clay. The porous clay film obtained by this method has a characteristic of high flexibility. However, although it is understood that the thin clay film of the literature has better flexibility than the thin clay film of Japanese Patent No. 3855003, it has poor strength compared to the thin clay film of Japanese Patent No. 3855003. Thus, similar to the explanation given above in relation with Japanese Patent No. 3855003, a structural disruption like cracks and fissures may easily occur. Further, for producing the porous clay film of Japanese Patent Application Laid-Open (JP-A) No. 2006-188418, control of content and evaporation rate of moisture is important and storing the film in a humid environment before heating or very rapid heating is necessary. For such reasons, from the viewpoint of having suitable flexibility required for a gasket, the porous clay film of Japanese Patent Application Laid-Open (JP-A) No. 2006-188418 also has a difficulty in production.

Under the circumstances, an object of the present invention is to provide a means to achieve a sufficient sealing property even when a clay film having excellent heat resistance is used in an environment with high temperatures exceeding 600° C., to fully prevent a deterioration in property caused by a structural change in an environment with moisture and high temperature exceeding 600° C., and to prevent a decrease in performance of a product due to sodium elution.

In view of the problems described above, the inventors of the present invention found that, with application in a semi-finished product state to a product subjected to high temperature load exceeding 600° C., a property deterioration can be fully prevented even when it is used at temperatures exceeding 600° C. for releasing hydroxyl groups at which structure disruption is caused, and also found that the sealing property can be significantly improved based on a mechanism of expansion caused by thermal decomposition of additives of which content can be easily adjusted. They also recognized that, in addition to the structure disruption described above, sodium ions are dehydrated and bind to oxygen atoms of silicate surface at the temperature level described above, and accordingly completed the present invention.

That is, the present invention (1) relates to a member made of a clay film which contains aligned clay particles in the structure thereof and contains, among the clay particles and/or among clay particle layers, a substance decomposing at temperature exceeding 100° C. but not exceeding the temperature allowing the release, as water, of structural hydroxyl groups in the clay particles, wherein the member is to be employed in an environment at temperatures equal to or higher than the decomposition temperature of the aforesaid substance.

The present invention (2) relates to the member according to (1), wherein the temperatures equal to or higher than the decomposition temperature are temperatures allowing the release, as water, of structural hydroxyl groups in the clay particles.

The present invention (3) relates to the member of the present invention (1) or the present invention (2) above, characterized in that the clay particles are at least one selected from the group consisting of kaolinite, dickite, halloysite, chrysotile, lizardite, amesite, pyrophillite, talc, montmorillonite, beidellite, nontronite, stevensite, saponite, hectorite, sauconite, dioctahedral vermiculite, trioctahedral vermiculite, muscovite, paragonite, illite, sericite, phlogopite, biotite, lepidolite, and layered titanate.

The present invention (4) relates to the member according to any one of the present inventions (1) to (3), characterized in that the substance is an organic substance.

The present invention (5) relates to the member according to the present invention (4), characterized in that the organic substance is at least one selected from the group consisting of a cyclic monomer, a multiple carbon bond-based monomer, a monofunctional monomer, a polyfunctional monomer, a homopolymer thereof, and a copolymer thereof.

The present invention (6) relates to the member according to the present invention (5), wherein the organic substance is ε-caprolactam.

The present invention (7) relates to the member according to the present invention (4), characterized in that the organic substance is an organic onium ion.

The present invention (8) relates to the member according to invention. (7), characterized in that the organic onium ion is at least one selected from the group consisting of an ammonium ion, a phosphonium ion, a pyridinium ion, and an imidazolium ion.

The present invention (9) relates to the member according to any one of the present inventions (1) to (3), characterized in that the substance is a foaming agent.

The present invention (10) relates to the member according to the present invention (9), wherein the foaming agent is at least one selected from the group consisting of an organic foaming agent and an inorganic foaming agent.

The present invention (11) relates to the member according to any one of the present inventions (1) to (10), wherein the member is expanded by heating at temperatures equal to or higher than the decomposition temperature of the substance to give a seal member.

The present invention (12) relates to the member according to any one of the present inventions (1) to (11), wherein the member is a member which becomes a seal member with a low sodium elution degree to have a sodium extraction amount of 100 ppm or less when the member is heated to temperatures allowing the release, as water, of structural hydroxyl groups in the clay particles.

The present invention (13) relates to a seal member for filling ribs in a narrow fixed space having ribs, wherein the seal member is formed by fixedly arranging the member according to the present invention (11) in a narrow fixed space having ribs at temperatures below the decomposition temperature of the substance and arranging it in an environment at equal or higher temperatures than the decomposition temperature of the substance.

The present invention (14) relates to the seal member according to the present invention (13), wherein the seal member is a gasket.

The present invention (15) relates to a seal member with a low sodium elution to have a sodium extraction amount of 100 ppm or less, wherein the seal member is formed by fixedly arranging the member according to the present invention (12) in a space which may have a problem of sodium elution at temperatures below the decomposition temperature of the substance and arranging it in an environment at equal or higher temperatures than the decomposition temperature of the substance which temperatures are also temperatures allowing the release, as water, of structural hydroxyl groups in the clay particles.

The present invention (16) relates to the seal member with low sodium elution according to the present invention (13) above, wherein the seal member with low sodium elution is a gasket for a fuel cell.

The present invention (17) relates to a clay dispersion used for production of the member according to any one of the present inventions (1) to (12), which is obtained by dispersing clay particles and the substance in water, an organic solvent, or a mixture solvent thereof.

The present invention (18) relates to a method of producing the member according to any one of (1) to the present invention (12), comprising steps of coating the dispersion according to the present invention (17) on a substrate, drying, and releasing it from the substrate.

Herein below, the meaning of the terms used in the specification will be explained. The term “structural water” means what is present as a hydroxyl group at room temperature instead of being present in the form of water molecule, but is released as water under heating at high temperature. The term “structural hydroxyl groups” means hydroxyl groups having a form of the structural water contained in clay as being present in the clay.

### BRIEF DESCRIPTION OF THE DRAWINGS

FIG. 1(A) is a concept drawing for illustrating the layered structure of clay particles. FIG. 1(B) is an electron microscopic image of the clay particles (montmorillonite);

FIG. 2 is an image (cross sectional image) of the clay film of Example 1, wherein the image is obtained by scanning electron microscopy;

FIG. 3 is an X-ray diffraction chart of the clay film of Example 1;

FIG. 4 illustrates the result of thermogravimetry (TG) of ε-caprolactam, which is an additive used in the clay film of Example 1;

FIG. 5 illustrates the results of IR analysis of the clay film of Example 1, wherein the clay film has been subjected to no heat-treatment or heat-treatment at each temperature of 400, 600, or 800° C.;

FIG. 6 is an image of flanges, wherein the clay film of Example 1 is being inserted between them;

FIG. 7 is an image showing the results of testing an occurrence of cracks and fissures and testing the sealing property of Example 1; and

FIG. 8 is an image (cross sectional image) showing the results of testing an occurrence of cracks and fissures and testing the sealing property of Example 1.

### DETAILED DESCRIPTION OF THE INVENTION

<Constitution of Members>

(Constitutional Components)

Thin Clay Film

The main constitutional components of the clay film in the semi-finished product of the present invention is natural clay and/or synthetic clay, and examples thereof include at least one selected from the group consisting of kaolinite, dickite, halloysite, chrysotile, lizardite, amesite, pyrophillite, talc, montmorillonite, beidellite, nontronite, stevensite, saponite, hectorite, sauconite, dioctahedral vermiculite, trioctahedral vermiculite, muscovite, paragonite, illite, sericite, phlogopite, biotite, lepidolite, and layered titanate. Among these, preferred are smectites, i.e., montmorillonite, beidellite, nontronite, saponite, and hectorite. As used herein, the term “clay” means particles having particle size range of 2 μm or less as defined by International Society of Soil Science (ISSS). More specifically, it indicates a silicate mineral having hydroxyl groups and a layered oxide having hydroxyl groups. Herein below, suitable clay components are explained in greater detail.

Smectite, which is a layered clay mineral, is a layered silicate mineral having 2:1 type structure in which negative charges included in silicate layer is from 0.3 to 0.6. Thus, the interlayer bonding is weak, the interlayer cations have an exchangeability, and water molecules or organic molecules can be easily introduced to the interlayers. Interlayer distance varies greatly depending on type of the interlayer cations and interlayer molecules. Included in the smectite are montmorillonite, beidellite, nontronite, saponite, and hectorite, and they can be appropriately used as the clay of the present invention.

Smectite has a negative permanent layer charge on the surface of crystal layer, and to compensate such charge, cations of an alkali metal like Na⁺ and K⁺ or an alkali earth metal like Ca²⁺ and Mg²⁺ are adsorbed in the interlayer which is a space between the crystals. These cations are present as a hydrate having water molecules and can be freely ion-exchanged with other cations, for example, organic cations. Na type montmorillonite has a weak electric attraction between aluminosilicate layers due to addition of Na⁺ ions. Specifically, Na⁺ ions are hydrated with water molecules, which are then intercalated between the interlayers, consequently showing macroscopic volume expansion. An organically modified clay modified to be dispersed in an organic solvent or a molten resin by replacing the interlayer ions like Na⁺ ion with an organic ion having high affinity for a solvent can be also used in the present invention. Representative examples of the organic ion used for the modification include an organic onium ion like an ammonium ion, a phosphonium ion, a pyridinium ion, an imidazolium ion, etc.

In the present invention, when the smectite like montmorillonite is used as a main component, it is preferable to use in combination mica like muscovite, paragonite, illite, sericite, phlogopite, biotite, lepidolite, etc. In such a case, it is preferable to use mica in an amount of 1 to 50% by weight compared to total weight of the raw materials (solid matters) for the member. Expandable mica is preferably used in the present invention because it has a characteristic that, once brought into contact with water, it adsorbs water molecules in the crystal interlayers to expand, and eventually separated from each other to disperse in water. Further, an organically modified mica to be dispersed in an organic solvent or a molten resin by replacing the interlayer cations with an organic ion having high affinity for a solvent can be also used. Compared to the smectites like montmorillonite etc., mica has higher aspect ratio of particles, and the layer charge of expandable mica is 0.6 to 1.0, which is bigger than that of smectite of 0.3 to 0.6. For such reasons, the electric attraction between aluminosilicate layers is strong based on interlayer addition of Na⁺ ions, and the expanding property in a solvent is lower than the smectite. Layered structure of the particles includes several tens to several hundreds of layers, and the layer thickness is in the range of several tens to several hundreds of nanometers. The particle diameter in a solvent is larger than that of the smectite. For such reasons, by using mica in combination when the smectite like montmorillonite is used as a main constitutional component, solvent removal efficiency at the time of drying for obtaining the semi-finished product of the present invention can be increased, or by eliminating internal moisture at high temperatures or forming a route for exhausting a gas generated, a foaming expansion phenomenon in a direction of film thickness can be controlled. The addition amount of mica is appropriately adjusted to obtain an optimum sealing effect, considering efficiency of a drying process and a foaming phenomenon at high temperatures at which the semi-finished product is used. However, when it is present in an amount of more than 50% by weight of the total weight of the semi-finished product of the present invention, mica, which has less dispersability in a solvent than the smectite like montmorilonite, becomes the main component. As a result, strength of the clay film is lowered, a foaming expanding property in a direction of film thickness is insufficient at the time of heating due to large particle diameter, and a sealing property for filling ribs in a narrow fixed space required for the present invention may not be easily obtained, and therefore undesirable.

Additives

The member according to the present invention essentially contains, among the clay particles and/or among clay particle layers, a substance decomposing at temperatures exceeding 100° C. but not exceeding the temperature allowing the release, as water, of structural hydroxyl groups in the clay particles, in addition to the clay as a main constitutional component. Herein, examples of the substance that are present among the clay particles and/or among clay particle layers and decomposes at temperatures exceeding 100° C. but not exceeding the temperature allowing the release, as water, of structural hydroxyl groups in the clay particles include an organic substance and a foaming agent. Herein below, the substance is explained in greater detail.

First, examples of the organic substance include a monomer, a polymer and an organic onium ion. Specific examples of the monomer and polymer include a cyclic monomer, a multiple carbon bond-based monomer, a monofunctional monomer, a polyfunctional monomer, a homopolymer thereof, and a copolymer thereof. Among these, preferred is ε-caprolactam, but not limited thereto. Further, examples of the organic onium ion include an ammonium ion, a phosphonium ion, a pyridinium ion, and an imidazolium ion. These substances are generally present in the form of an organic onium salt and present as an ion in a solvent before being added to clay.

Examples of the foaming agent include an organic foaming agent and an inorganic foaming agent. The foaming agent is not specifically limited as far as it fully decomposes and is capable of foaming in the temperature range employed. Specific examples of the organic foaming agent include dinitropentamethylene tetramine (DPT), an azo-based organic foaming agent like azodicarbon amide (ADCA), etc., and a hydrazine derivative like p,p′-oxybisbenzene sulfonyl hydrazide (OBSH), hydrazole dicarbon amide (HDCA). Examples of the inorganic foaming agent include sodium hydrogen carbonate and zirconium hydride, etc.

The sealing effect relating to the additives described above will be explained below. The additives present among the clay particles and/or clay particle layers are decomposed, gasified, and eliminated from the member. At the time of elimination, there are not many routes for the gas components to escape, as the clay particles are highly aligned and have a high gas barrier property. Thus, with widening of a space among the clay particles and/or clay particle layers, the member of the present invention can be expanded in a direction of film thickness within a narrow fixed space resulting from the widening, and as a result, the gaps are filled to enhance the sealing effect.

When the additives described above are added, they are used in the ratio of 1 to 30% by weight compared to the total weight of the raw materials (solid matters) for the member of the present invention. When the addition amount of the additives is less than 1% by weight, the amount of generated gas is small, thus a sufficient sealing effect cannot be obtained when it is used for a gasket, etc. When it is more than 30% by weight, many of them are decomposed by heating, heat resistance of the member of the present invention is impaired, and the density after eliminating gas is very small, and therefore a desired sealing effect may not be obtained.

Other Optional Components

The member of the present invention may contain other materials (e.g., graphite, metallic fiber, etc.) in addition to the clay as a main component. According to a composite treatment between the clay and other materials, physical properties like mechanical strength can be appropriately controlled.

(Structure, Shape, etc.)

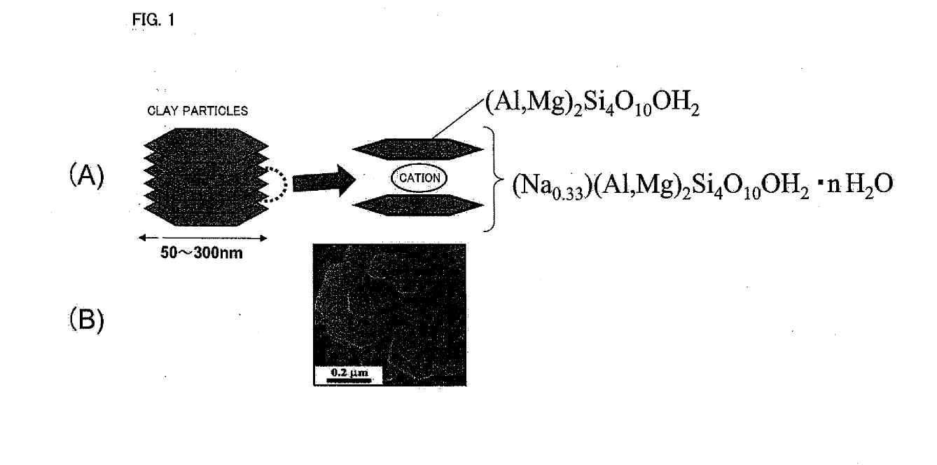

The member of the present invention has a structure in which layered clay particles are aligned. Herein, the term “layered clay particles are aligned” means that a unit structure layer (thickness of about 1 nanometer) of clay particles is overlaid in a direction of the layer surface to have high periodicity in a direction perpendicular to the layer surface. FIG. 1(A) is a concept drawing for illustrating the layered structure of clay particles. FIG. 1(B) is an electron microscopic image of the clay particles (montmorillonite). Therein the clay particles are described to have a particle size of 50 to 300 nm and atomic ratio of Na=0.33, but they are for exemplification only. As can be seen from FIG. 1, the clay particles consist of a plurality of layers, and each layer is negatively charged. Cations (sodium ions) are present between the layers. Overall, the structure is electrically neutralized.

Shape, size and thickness of the member of the present invention are determined depending on the use, but they are not specifically limited. The shape can be, for example, a circle, an oval, a ring, a quadrangle like a square and a rectangle, a polygon, etc. Regarding the thickness, film thickness can be, for example, 10 μm to 1 mm and preferably 10 to 200 μm. Further, to obtain a member with desired thickness or a thickness of 1 mm or more, lamination with multiple coating of a dispersion liquid or adhesion of members by using adhesives, adherents, etc. can be also employed.

(Properties)

The member of the present invention contains a clay film which contains, among the clay particles or/and among clay particle layers, a substance decomposing at temperatures exceeding 100° C. but not exceeding the temperature allowing the release, as water, of structural hydroxyl groups in the clay particles, and the member has an effect of improved sealing performance at temperatures exceeding the decomposition temperature of the aforesaid substance. In the temperature range described above, the member of the present invention has a very small linear expansion coefficient in a plane direction and excellent heat resistance. Specifically, the linear expansion coefficient in a plane direction is 15 ppm/° C. or less in the temperature range described above. The linear expansion coefficient is measured by a TMA (Thermo Mechanical Analysis), which is an instrument commonly used for thermo mechanical analysis. Specifically, the linear expansion coefficient in a plane direction is 15 ppm/° C. or less when measured under atmospheric condition with a load of 49 mN and temperature increase of 5.0° C./min.

(Production Method)

The member of the present invention can be produced as follows: a dilute and homogeneous clay dispersion is prepared, the dispersion is molded to a film shape on a substrate, therefrom the liquid as a dispersion medium is separated by various solid-liquid separation methods like centrifuge, filtration, vacuum drying, vacuum freeze-drying, or heating evaporation, the resultant matter is molded to a film shape, and the film is released from the substrate by adopting a condition to have sufficient strength required for the use as a self-supporting film with even thickness. Herein below, more detailed explanations are given.

First, natural clay, synthetic clay, or a mixture thereof is used as clay, with additives added. The mixture is added to water, an organic solvent, or a mixture solvent thereof, to give a dilute and homogeneous clay dispersion.

Herein, when an organic onium ion is used as additives, an organification treatment for putting it in clay interlayers by ion exchange with the cations in the clay interlayers is performed. First, as clay, natural clay, synthetic clay, or a mixture thereof is added to water or a mixture solvent of water and an organic solvent, followed by homogeneous dispersion. Then, predetermined organic onium salts are added thereto and stirred further. At that time, the cations in the clay interlayers are subjected to ion exchange with the organic onium ions, and as a result, by having the organic onium ions in the clay interlayers, the hydrophilic character of the clay due to the presence of cations is changed to a hydrophobic character due to the presence of organic onium ions. Consequently, the clay precipitates in water or a mixture solvent with an organic solvent. The solvent is removed by solid-liquid separation to give organically modified clay, which is then added to water, an organic solvent, or a mixture solvent thereof and stirred to produce a dilute and homogenous clay dispersion.

Concentration of the clay dispersion is preferably 0.5 to 20% by weight, and more preferably 3 to 10% by weight compared to the total weight of the liquid. When the concentration of the clay dispersion is too low, there is a problem that a long period of time is required for drying. On the other hand, when the concentration of the clay dispersion is too high, there is a problem that clay is not easily dispersed so that a homogeneous film may not be obtained.

Next, the clay dispersion is molded to a film shape on a substrate. The substrate can be a sheet type substrate with smooth surface or a substrate with complex shape like a stereo shape including globular shape or a shape with grooves, etc., and materials and thickness of the substrate are not limited. Specifically, various films, metal foils, metal plates, and other various substrates can be used. More specifically, a plastic sheet substrate with a thickness of 50 μm to 1 mm can be preferably used. Examples of the substrate material include polyethylene terephthalate (PET), polyethylene naphthalate (PEN), triacetyl cellulose (TAC), polyarylate, polyimide, polyether, polycarbonate (PC), polysulfone, polyether sulfone, cellophane, aromatic polyamide, polyethylene, polypropylene, and polyvinyl alcohol. Further, for the purpose of improving a releasing property with the clay film, a treatment with a releasing agent can be carried out on the surface of a plastic sheet, or for the purpose of improving adhesion or wettability with the clay film, a surface treatment like a corona treatment, a plasma treatment, etc., or an easy adhesion treatment can be also carried out.

The method of molding to have a film shape is not specifically limited, as far as it can provide an even coating. Examples thereof include coating techniques such as applicator coating, bar coating, air doctor coating, blade coating, knife coating, reverse coating, transfer roll coating, gravure roll coating, kiss coating, cast coating, spray coating, slot orifice coating, calender coating, electro-deposition coating, dip coating, or die coating, printing techniques such as letterpress printing such as flexo printing, intaglio printing such as direct gravure printing or offset gravure printing, lithography such as offset printing, stencil printing such as screen printing, etc. Otherwise, it is also possible to coat and mold to obtain a film shape manually by using a tool like a spatula, a brush, etc. in order to prevent blister.

Next, the solvent is separated from the clay dispersion, and the resultant matter is molded to a film shape. In this case, the separation method is not specifically limited as far as it is a means for separating the solvent as a dispersion medium, and preferable examples including various solid-liquid separation methods like centrifuge, filtration, vacuum drying, vacuum-freeze drying, and heating evaporation, or a combination of one or more thereof are employed to obtain the member of the present invention.

Among the methods described above, when the heating evaporation is used, for example, a dispersion which has been deaerated in advance by vacuum or defoaming treatment is molded to a film shape on a support film, preferably a PET film, by coating, and dried at temperature condition of 60 to 170° C., for example, to give a clay film. The drying condition is set to achieve sufficient elimination of various liquid fractions by evaporation. When the temperature is too low, there is a problem that a long period of time is required for drying. On the other hand, when the temperature is too high, there is a problem that alignment degree of the clay particles is lowered due to an occurrence of convection current. As such, type of the solvent to be used is appropriately selected depending on an amount. The member of the present invention can be obtained by releasing it from a PET film after drying. Further, it is also possible that the member of the present invention released from a PET film is additionally heated to completely remove the solvent, pressed, or subjected to a surface polishing treatment such as a press or a calendar roll treatment to control the density.

The clay film itself as a member of the present invention uses layered silicate as a main component, and as a basic constitution, 90% by weight of natural or synthetic layered silicate having hydroxyl groups with a layer thickness of about 1 nm, a particle diameter of 2 μm or less, an aspect ratio of about 1000 and 10% by weight of natural or synthetic low molecular or high molecular additives are exemplified. The clay film is produced by alignment of layered crystals with a thickness of about 1 nm in the same direction, followed by tight lamination.

<Method of Using a Member>

Next, a method of using the member of the present invention is explained. The member of the present invention is fixedly arranged in a narrow fixed space having ribs at temperatures lower than the decomposition temperature of the additives and used as a seal member for preventing leakage of liquid or gas from the ribs. Examples of the narrow fixed space having ribs include a flange surface of a pipe or an electrode surface of a fuel cell. The member of the present invention is placed in an environment at temperatures equal to or higher than the decomposition temperature of a substance contained among the clay particles and/or among clay particle layers, and depending on a case, at temperatures allowing the release, as water, of structural hydroxyl groups in the self-supporting thin clay film. As used herein, the term “decomposition temperature of the substance” represents a temperature at which weight loss of the substance starts to occur when the temperature is gradually increased, and it indicates gasification by vaporization, evaporation, or sublimation. It is a value measured by thermogravimetry (TG), a common heat analysis method. Meanwhile, according to this measurement, the weight loss until the temperature around 100° C. is caused by evaporation of moisture contained or adsorbed in the substance, and therefore the temperature decrease in the range of 100° C. or more in the thermogravity curve obtained by thermogravimetry (TG) is taken as the thermal decomposition temperature of the present invention. Specifically, peak temperature in a derivative thermogravity curve (DTG curve), which is obtained by plotting a weight change ratio against temperature, is taken as the thermal decomposition temperature of the present invention. Further, the “temperature allowing the release, as water, of structural hydroxyl groups in the self-supporting thin clay film” can be measured by infrared spectroscopy (IR) as a common analysis method. That is, it indicates a temperature at which a peak originating from structural hydroxyl group in the clay, specifically, a peak at 3710 to 3620 cm⁻¹ representing an absorption by stretch vibration of structural hydroxyl group in IR, is lost. Herein below, the method for using {method of converting the member into a product (for example, a seal member)} is explained in greater detail.

First, the member of the present invention is placed in an environment at temperatures equal to or higher than the decomposition temperature of a substance contained among the clay particles and/or among clay layers. Herein, the decomposition temperature may vary depending on type of a substance to be contained. Depending on an environment and use of the member of the present invention, the substance to be contained is appropriately selected, and the decomposition temperature also varies. When the member of the present invention is placed in such an environment, a mechanism of widening a space among the clay particles and/or clay layers, which is caused by gas generated by decomposition of the substance contained in the inside of the clay film, is activated, and volume expansion in a direction of film thickness is caused to fill the ribs between flanges. Thus, it is useful as a semi-finished product of a gasket or a seal member which requires a high sealing property as well as heat resistance.

Furthermore, the member of the present invention may be also placed in an environment at temperatures allowing the release, as water, of structural hydroxyl groups in the self-supporting clay film. When the self-supporting clay film of the present invention is placed in an environment “at temperatures allowing the release, as water, of structural hydroxyl groups,” it is known that a structural disruption of the self-supporting clay film is caused. However, when it is applied in advance to a product in the form of a member and placed in the environment above (for example, inserted between flanges), reduction in heat resistance or sealing property due to structural disruption can be significantly prevented. Further, when exposed to high temperatures at the level described above, as a result of interlayer fixing showing binding of sodium ions to oxygen atoms on surface of silicate, a property of low sodium elution that is described in detail below can be exhibited. For such reasons, it is beneficial for use in which sodium elution may cause a problem, for example, a gasket of a fuel cell. Herein, for using the member of the present invention, it is also possible that the member is heated to temperatures allowing the release, as water, of structural hydroxyl groups before applying it to a product to give a member with low sodium elution, and then the member is fixed to a product. However, according to this method in which the member is heated before fixing to a product, the member becomes hardened due to heating, and thus cracks or fissures may easily occur. Thus, it is generally difficult to satisfy the desired properties as the sealing property is deteriorated when the member is fixed to a product. In this connection, the ideal mode of using the member of the present invention includes applying it to a subject product and heating it to the temperatures allowing the release, as water, of structural hydroxyl groups. As a result, an occurrence of cracks and fissures in the member can be effectively prevented, and a sealing property can be surely obtained by filling ribs in a narrow fixed space having ribs according to expansion of the clay film.

<Physical Properties of Member with Low Sodium Elution at the Time of Use>

The member with low sodium elution that is formed by heating (i.e., heating to the temperatures allowing the release, as water, of structural hydroxyl groups in the self-supporting clay film) the member of the present invention has a sodium ion extraction amount of 100 ppm or less (preferably, 50 ppm or less). As used herein, the term “sodium ion extraction amount” means a value obtained by adding 5.0 g of a member to be measured and 50 ml of pure water to an extraction vessel, sealing the vessel, and keeping the vessel in a dryer at 121° C. for 20 hours followed by cooling to room temperature, and quantifying an amount of sodium ions contained in a 10-fold diluted sample by atomic absorption spectroscopy.

### Examples

### Example 1

### 1. Production of a Clay Film as a Member

15 g of natural montmorillonite “KUNIPIA G” (trade name, manufactured by Kunimine Industries Co., Ltd.) and 4 g of synthetic mica “SOMASIF ME-100” (trade name, manufactured by Co-op Chemical Co., Ltd.) as clay and 1 g of ε-caprolactam (manufactured by Wako Pure Chemical Industries, Ltd.) as an additive were added to 330 g of distilled water, and stirred for 60 min with revolution number of 5,000 rpm by using ACE HOMOGENIZER “AM-001” (trade name, manufactured by Nihonseiki Kaisha Ltd.) to obtain a homogeneous clay dispersion with concentration of about 6%. The clay dispersion was subjected to a vacuum treatment in a vacuum dryer to remove foams, and the resultant was applied onto PET “EMBLET S50” (trade name, manufactured by Unitika Ltd.) in a film form by using an applicator. The coated PET was dried for 1 hour at temperature condition of 100° C. in an oven with forced ventilation. After being released from PET, a self-supporting clay film with a thickness of about 40 micrometers was obtained.

### 2. Physical Properties of the Clay Film as a Member

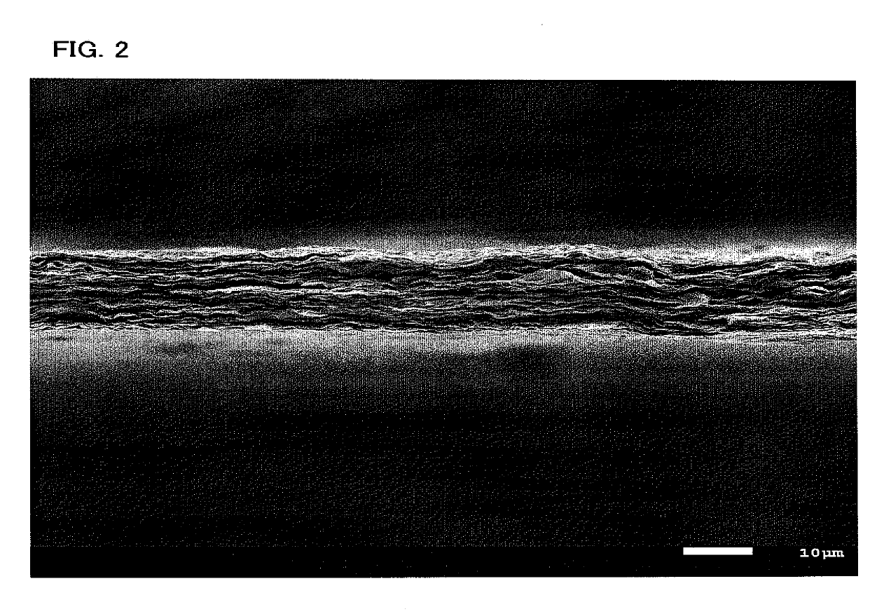

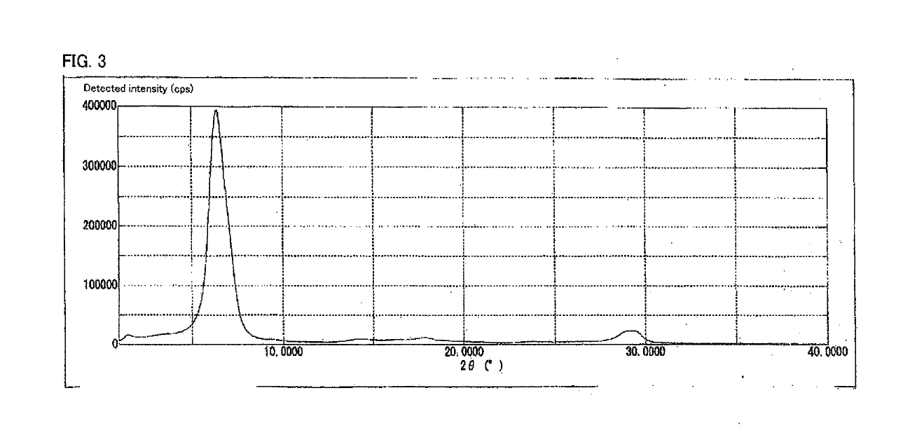

An image of the clay film which was observed using a scanning electron microscope is shown in FIG. 2. From FIG. 2, it is found that the clay particles are highly aligned. The X ray diffraction chart of the clay thin film is shown in FIG. 3. A series of sharp bottom surface reflection peaks (001), (002), (003), (004), and (005) were observed, showing that the particles of the clay film are well oriented.

### 3. Measurement of Decomposition Temperature of ε-Caprolactam

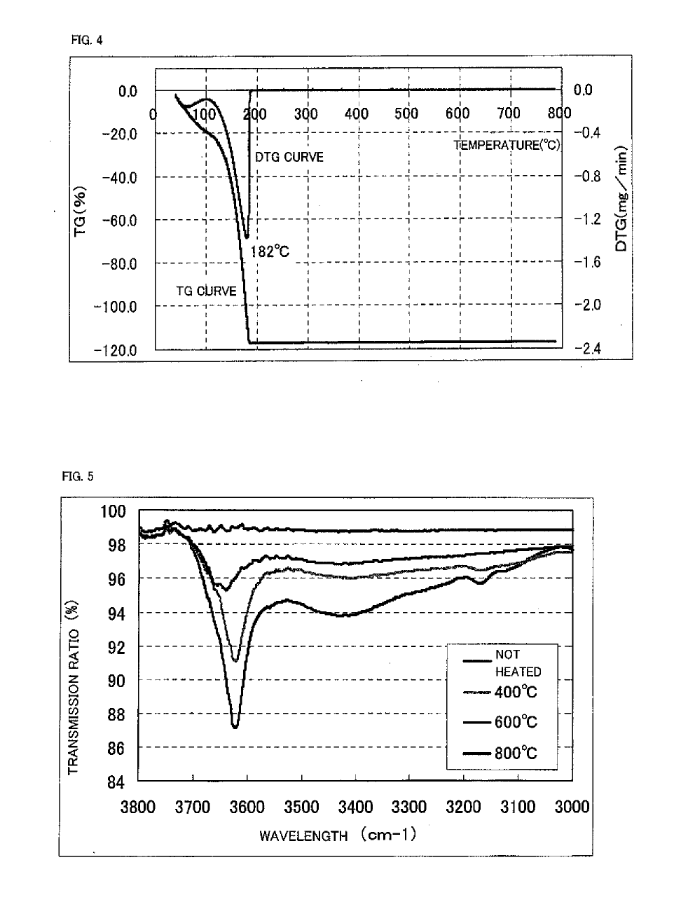

Next, in order to determine the decomposition temperature of ε-caprolactam contained in the film, the thermogravimetry (TG) of ε-caprolactam was carried out in the temperature range from room temperature to 800° C., an air environment of 300 ml/min, and temperature increase of 5° C./min by using TG/DTA6200, EXSTAR6000 station (manufactured by Seiko Instruments Inc.) (FIG. 4). As a result, it was found that the substance is decomposed at 182° C.

### 4. Determination of “Temperature Allowing the Release, as Water, of Structural Hydroxyl Groups in the Self-supporting Clay Film” in Clay Film as a Member

Next, in order to determine the temperature allowing the release, as water, of structural hydroxyl groups in the film, IR analysis (FIG. 5) was carried out for the film which has been heat-treated at various temperatures including no heat treatment (bottom line), 400° C. (second line from the bottom), 600° C. (second line from the top), and 800° C. (top line). From the IR analysis, peak at 3622 cm⁻¹ representing the absorption by stretch vibration of structural water was identified, and the heating temperature for the film subjected to heat treatment at which the peak is lost is taken as a temperature allowing the release, as water, of structural hydroxyl groups in the film. As a result, it was found that the structural water in the film is released in the temperature range of 600° C. to 800° C., i.e., the film is to be heated to temperatures sufficient to decompose the substance but not exceeding temperatures allowing the release, as water, of structural hydroxyl groups in the clay particles of the film.

### 5. Test for Measuring Sodium Elution Amount After Heating of the Clay Film as a Member

As it was confirmed from the test results of the above 3 and 4 that the “decomposition temperature of a substance” in the clay film is 182° C. and the “temperature allowing the release, as water, of structural hydroxyl groups in the self-supporting clay film” is 600° C. to 800° C., the clay film was heated at 800° C., which is the upper limit of the temperature range. The heating condition includes increasing temperature for 1 hour keeping for 1 hour→natural cooling. After that, 5.0 g of a member to be measured and 50 ml of pure water were added to an extraction vessel and sealed, the vessel was kept in a dryer at 121° C. for 20 hours followed by cooling to room temperature, and an amount of sodium ions in a 10-fold diluted sample was measured by atomic absorption spectroscopy. Further, for comparison, the sodium elution amount obtained after heating at 400° C. or 600° C., which is lower than the lower limit of the temperature range described above, was also measured. The results are shown in Table 1. As can be seen from this table, the extraction amount of sodium ions after heating is less than 1/10 of the amount before heating, i.e., 100 ppm or less.

TABLE 1

| Ion type | No heat | | | |
|---|---|---|---|---|
| (ppm) | treatment | 400° C. | 600° C. | 800° C. |
| Na | Dissolved | 400 ppm | 260 ppm | 34 ppm |

### 6. Test for Identifying Occurrence of Cracks and Fissures Caused by Heating and Determining Sealing Property After the Clay Film as a Member is Fixed to a Product

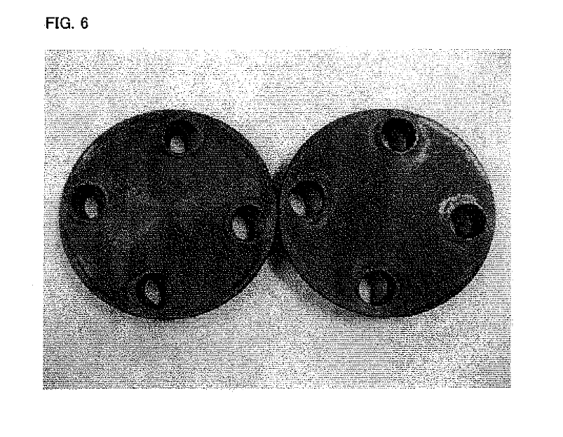

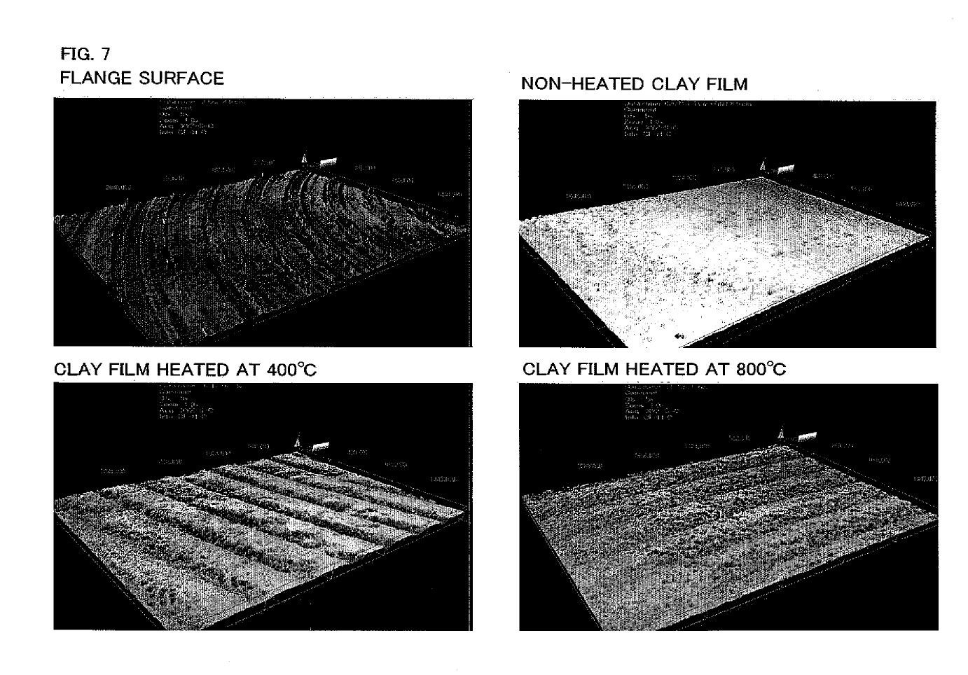

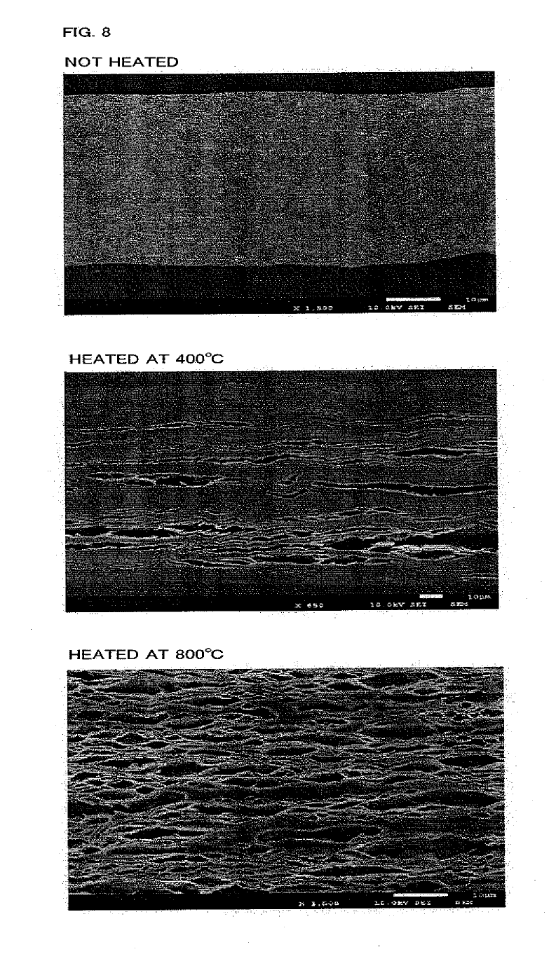

A clay film as a semi-finished product was cut to have an appropriate shape and inserted between the flanges shown in FIG. 6. After being fastened with jointing pressure of 4 MPa, it was heated under the same condition as the above-mentioned test 5. The results are shown in FIG. 7. As can be seen from FIG. 7, no occurrence of cracks or fissures was found in the member after heating (i.e., a member produced by heating of the semi-finished product). Further, as the film expands according to generation of voids inside the film by heating, ribs on the flange surface were filled to show an improved sealing property. FIG. 8(A) shows a structure of the film cross section at the time of heating at low temperature (400° C.) while FIG. 8(B) shows a structure of the film cross section at the time of heating at high temperature (800° C.). As shown in FIG. 8(A), when heating is carried out at the temperature exceeding the decomposition temperature of ε-caprolactam, which is an additive used, a structure to widen a gap among the clay particles and/or among clay particle layers, that is caused by decomposition of ε-caprolactam contained inside the clay film, starts to show up, and as a result, it was confirmed that a structure allowing volume expansion in a direction of film thickness is established inside the film. Further, as shown in FIG. 8(B), when heating is carried out at the temperature allowing the release, as water, of structural hydroxyl groups in the self-supporting clay film, a structure to widen a gap among the clay particles and/or among clay particle layers, that is caused by release of hydroxyl groups as water, starts to show up, and as a result, it was confirmed that a structure allowing volume expansion in a direction of film thickness is established inside the film.

### Examples 2 and 3

A self-supporting clay film with a thickness of about 40 micrometer was obtained in the same manner as Example 1 except that addition amount of natural montmorillonite “KUNIPIA G” (trade name, manufactured by Kunimine Industries Co., Ltd.) and synthetic mica “SOMASIF ME-100” (trade name, manufactured by Co-op Chemical Co., Ltd.) as clay and ε-caprolactam (manufactured by Wako Pure Chemical Industries, Ltd.) as an additive are adjusted to the ratio described in the following table.

TABLE 2

| | | | | Additives | | | |
|---|---|---|---|---|---|---|---|
| | | | | | Organic onium | Polymer | Foaming agent |
| | Clay | Mica | | | The Nippon | The Nippon | Wako Pure |
| | KUNIPIA G | ME-100 | NTS-5 | Monomer | Synthetic | Synthetic | Chemical |
| | Kunimine | Co-op Chemical | Topy Industries | Wako Pure | Chemical | Chemical | Industries, Ltd. |
| | Industries | Co., Ltd. | Ltd. | Chemical | Industry | Industry Co., Ltd. | Sodium |
| | Co., Ltd. | Na fluorine | Na tetrasilicon | Industries, Ltd. | Co., Ltd. | GOHSENOL | hydrogen |
| | Montmorillonite | mica | mica | ε-Caprolactam | EMI | NH-18 | carbonate |
| Example 1 | 75 | 20 | | 5 | | | |
| Example 2 | 65 | 20 | | 15 | | | |
| Example 3 | 50 | 20 | | 30 | | | |
| Example 4 | 91 | | | | 9 | | |
| Example 5 | 75 | 20 | | | | 5 | |
| Example 6 | 75 | 20 | | | | | 5 |
| Example 7 | 75 | | 20 | 5 | | | |

### Example 4

40 g of natural montmorillonite “KUNIPIA G” (trade name, manufactured by Kunimine Industries Co., Ltd.) as clay was added to 2000 g of distilled water, and the mixture was dispersed by stirring using a stirrer, and added with 10 g of 1-ethyl-3-metnylimidazolium bromide (EMI-Br) (manufactured by The Nippon Synthetic Chemical Industry Co., Ltd.). According to an ion exchange reaction between the sodium ions in natural montmorillonite and the imidazolium ions, the montmorillonite which contains 1-ethyl-2-buthylimidazolium ions within the interlayer was precipitated in the liquid. The solution was subjected to solid-liquid separation by using a centrifuge to obtain a montmorillonite clay cake which has moisture content of 85% and contains 1-ethyl-2-buthylimidazolium ions within the interlayer. To 120 g of the clay cake, 40 g of dimethyl formamide (DMF) as a dispersion organic solvent was added and the mixture was stirred for 60 min with revolution number of 5,000 rpm by using ACE HOMOGENIZER “AM-001” (trade name, manufactured by Nihonseiki Kaisha Ltd.) to obtain a montmorillonite dispersion containing 1-ethyl-2-buthylimidazolium, wherein the clay is expanded in a mixture solvent of distilled water and DMF to concentration of about 11%. The clay dispersion was subjected to a vacuum treatment in a vacuum dryer to remove foams, coated to have a film shape on PET “EMBLET S50” (trade name, manufactured by Unitika Ltd.) by using an applicator, dried for 1 hour at temperature condition of 100° C. in an oven with forced ventilation. After releasing it from PET and additional drying for 1 hour at temperature condition of 170° C., a self-supporting clay film with a thickness of about 40 micrometer was obtained. Regarding the addition ratio of “KUNIPIA G” as natural montmorillonite and 1-ethyl-3-metnylimidazolium (EMI) in the film, carbon atom analysis was carried out by using an atom analyzer Model EA1108 (trade name, manufactured by CARLO ERBA). The addition ratio was calculated from the analysis results. As a result, the addition ratio between KUNIPIA G and EMI was found to be 91:9% by weight.

### Example 5

A self-supporting clay film with a thickness of about 40 micrometer was obtained in the same manner as Example 1 except that “polyvinyl alcohol (GOHSENOL NH-18)” (trade name, manufactured by The Nippon Synthetic Chemical Industry Co., Ltd.) was used as an additive.

### Example 6

A self-supporting clay film with a thickness of about 40 micrometer was obtained in the same manner as Example 1 except that an inorganic foaming agent “sodium hydrogen carbonate” (manufactured by Wako Pure Chemical Industries, Ltd.) was used as an additive.

### Example 7

A self-supporting clay film with a thickness of about 40 micrometer was obtained in the same manner as Example 1 except that “NTS-5 (solid matter; 6%)” (trade name, manufactured by Topy Industries Ltd.) was used as synthetic mica.

### Comparative Example 1

A self-supporting clay film with a thickness of about 40 micrometer was obtained in the same manner as Example 1 except that only natural montmorillonite “KUNIPIA G” (trade name, manufactured by Kunimine Industries Co., Ltd.) was used as clay.

### 7. Test for Determining Sealing Property According to Heating After Application of Clay Film as a Member to a Product (Change in Thickness According to Volume Expansion)

A clay film as a member was cut to have an appropriate shape and inserted between the flanges shown in FIG. 6 followed by heating under the same condition as above 5 (for any example, the decomposition temperature of less than 600° C. was confirmed according to the method described in “3” above). After that, the thickness of the clay film was measured by using DIGITAL MICROMETER μ-Mate (trade name, manufactured by SONY) and it was confirmed that there is a volume expansion in a direction of film thickness compared to the thickness before insertion between flanges. The results are shown in Table 3. The film produced only with the clay of Comparative Example 1 showed an occurrence of cracks or fissure after heating which follows insertion between flanges, and therefore a sealing performance cannot be obtained.

TABLE 3

| | | | | | | Expansion ratio (increase ratio) | | |
|---|---|---|---|---|---|---|---|---|
| | | | | | | of film thickness | | |
| | Composition | | | | | Heated at | Heated at | Heated at |
| | Clay | Mica | | Additives | | 400° C. | 600° C. | 800° C. |
| Example 1 | 75 | 20 | ME-100 | 5 | ε-Caprolactam | 90% | 70% | 126% |
| Example 2 | 65 | 20 | ME-100 | 15 | ε-Caprolactam | 82% | 61% | 65% |
| Example 3 | 50 | 20 | ME-100 | 30 | ε-Caprolactam | 75% | 53% | 57% |
| Example 4 | 91 | | | 9 | EMI | 11% | 15% | 59% |
| Example 5 | 75 | 20 | ME-100 | 5 | PVA | 85% | 79% | 125% |
| Example 6 | 75 | 20 | ME-100 | 5 | Sodium hydrogen carbonate | 105% | 118% | 123% |
| Example 7 | 75 | 20 | NTS-5 | 5 | ε-Caprolactam | 35% | 54% | 70% |

### 8. Test for Determining Sealing Property According to Heating After Application of Clay Film as a Member to a Product (Sealing Property in Ribs of Flange Surface)

A clay film as a member was cut to have an appropriate shape and inserted between the flanges shown in FIG. 6, followed by heating under the same condition as above 5. After that, the roughness of the clay film surface was measured by using a contact type surface roughness measuring instrument, Surfcorder SE1700α (manufactured by Kosaka Laboratory Ltd.). In view of surface roughness of the ribs on surface of the flange used, a sealing property in the ribs of flange surface was determined based on a difference in surface roughness of the ribs on flange surface. The results are given in Table 4.

TABLE 4

| | | | | | | Surface roughness (μm) | | | | | | | |
|---|---|---|---|---|---|---|---|---|---|---|---|---|---|
| | | | | | | Before | | Heated at | | Heated at | | Heated at | |
| | Composition | | | | | heating | | 400° C. | | 600° C. | | 800° C. | |
| | Clay | Mica | | Additives | | Ra | Rz | Ra | Rz | Ra | Rz | Ra | Rz |
| Flange surface roughness | | | | | | 3.28 | 15.01 | | | | | | |
| Example 1 | 75 | 20 | ME-100 | 5 | ε-Caprolactam | 0.30 | 2.44 | 2.52 | 9.37 | 2.14 | 9.21 | 3.28 | 15.05 |
| Example 2 | 65 | 20 | ME-100 | 15 | ε-Caprolactam | 0.31 | 2.45 | 2.41 | 9.11 | 2.61 | 9.35 | 3.03 | 12.16 |
| Example 3 | 50 | 20 | ME-100 | 30 | ε-Caprolactam | 0.29 | 2.40 | 2.32 | 9.05 | 2.42 | 9.03 | 2.96 | 11.92 |
| Example 4 | 91 | — | — | 9 | EMI | 0.41 | 2.09 | 0.31 | 1.65 | 0.55 | 3.18 | 0.78 | 4.39 |
| Example 5 | 75 | 20 | ME-100 | 5 | PVA | 0.33 | 2.52 | 2.46 | 9.27 | 2.46 | 9.31 | 3.23 | 14.97 |
| Example 6 | 75 | 20 | ME-100 | 5 | Sodium hydrogen carbonate | 0.34 | 2.51 | 2.88 | 9.71 | 2.91 | 10.87 | 3.34 | 15.22 |
| Example 7 | 75 | 20 | NTS-5 | 5 | ε-Caprolactam | 0.32 | 2.47 | 2.49 | 7.74 | 2.60 | 8.85 | 3.15 | 13.33 |

As can be seen from Table 3 and Table 4, it was confirmed that the additives are decomposed, gasified, and expanded in a thickness direction of the clay film to fill gaps in the flange, exhibiting the sealing performance accordingly. Further, it was also confirmed that, at the temperature of 800□C allowing the release, as water, of structural hydroxyl groups in the clay, the expansion in the thickness direction is high and the sealing effect resulting from filling gaps between the flanges is further enhanced.

1. A member comprising a clay film which comprises aligned clay particles in the structure thereof and comprises, among the clay particles and/or among layers of clay particles, a substance decomposing at temperatures exceeding 100° C. but not exceeding temperatures allowing the release, as water, of structural hydroxyl groups in the clay particles, wherein the member is to be employed in an environment at temperatures equal to or higher than the decomposition temperature of the aforesaid substance.

2. The member according to claim 1, wherein the temperatures equal to or higher than the decomposition temperature are temperatures allowing the release, as water, of structural hydroxyl groups in the clay particles.

3. The member according to claim 1, wherein the clay particles are at least one selected from the group consisting of kaolinite, dickite, halloysite, chrysotile, lizardite, amesite, pyrophillite, talc, montmorillonite, beidellite, nontronite, stevensite, saponite, hectorite, sauconite, dioctahedral vermiculite, trioctahedral vermiculite, muscovite, paragonite, illite, sericite, phlogopite, biotite, lepidolite, and layered titanate.

4. The member according to claim 1, wherein the substance is an organic substance.

5. The member according to claim 4, wherein the organic substance is at least one selected from the group consisting of a cyclic monomer, a multiple carbon bond-based monomer, a monofunctional monomer, a polyfunctional monomer, a homopolymer thereof, and a copolymer thereof.

6. The member according to claim 5, wherein the organic substance is ε-caprolactam.

7. The member according to claim 4, wherein the organic substance is an organic onium ion.

8. The member according to claim 7, wherein the organic onium ion is at least one selected from the group consisting of an ammonium ion, a phosphonium ion, a pyridinium ion, and an imidazolium ion.

9. The member according to claim 1, wherein the substance is a foaming agent.

10. The member according to claim 9, wherein the foaming agent is at least one selected from the group consisting of an organic foaming agent and an inorganic foaming agent.

11. A seal member comprising the member of claim 1, wherein the seal member is expandable by heating at temperatures equal to or higher than the decomposition temperature of the substance.

12. A seal member comprising the member of claim 1, wherein the heating is to temperatures at which structural hydroxyl groups in the clay particles are released as water so that the seal member has a low sodium elution degree, expressed as a sodium extraction amount, of 100 ppm or less.

13. A seal member for filling ribs in a narrow fixed space having ribs, wherein the seal member is formed by fixedly arranging the seal member according to claim 11 in the narrow fixed space having ribs at temperatures less than the decomposition temperature of the substance and heating the seal member to temperatures equal to or higher than the decomposition temperature of the substance.

14. The seal member according to claim 13, wherein the seal member is a gasket.

15. The seal member of claim 13, wherein the space is one in which sodium elution is problematical and the temperatures to which the seal member is heated are temperatures at which structural hydroxyl groups in the clay particles are released as water so that the seal member has a low sodium elution degree, expressed as a sodium extraction amount, of 100 ppm or less.

16. A gasket for a fuel cell comprising the seal member according to claim 15.

17. The member of claim 1, wherein the film is formed from a dispersion of clay particles and the substance is water, an organic solvent, or a mixture of an organic solvent and water.

18. A method of producing the member according to claim 1, comprising coating a dispersion of clay particles and the substance in water, an organic solvent or a mixture of water and an organic solvent on a substrate, drying the coating to form a clay film, and releasing the clay film from the substrate.
